(19) United States
(12) Patent Application Publication
(10) Pub. No.: US 2004/0026350 A1
(43) Pub. Date: Feb. 12, 2004

(54) Articulated jib crane

(76) Inventor: Jean-Marc Yerly, Domdidier (CH)

Correspondence Address: Clifford W Browning, Bank One Center Tower, 111 Monument Circle Suite 3700, Indianapolis, IN, 46204-5137, US

(21) Appl. No.: 10/332,002

(22) PCT Filed: Jul. 10, 2001
(86) PCT No.: PCT/CH01/00432

(30) Foreign Application Priority Data
Jul. 11, 2000 (EP) 00810608.0

(51) Int. Cl. B66C 23/34; B66C 23/64

(52) U.S. Cl. 212/347; 74/490.01

(57) ABSTRACT

The invention concerns a load lifting and handling appliance with articulated jib, capable of being raised and inclined, comprising a mast, a jib foot articulated in rotation at its first end (35) to the top of the mast (21, 22, 29), a fly jib (41) articulated in rotation at the second end (36, 37) of the jib foot, said fly jib comprising on either side of its hinge pin (45) to the fly jib foot respectively a fly jib point (43) and a counter fly jib (42, 49), a jib-retaining assembly comprising at least a king post (16) and a jib tie (25), and at least a double acting stick cylinder (3) linking the jib foot to the fly jib, determining the angle between jib foot and fly jib. The foot portion proximate to said second end and the counter fly jib having conjugated shapes enabling the fly jib point to be urged in aligned position with the jib foot. The lifting appliance may comprise a mobile counterweight system (113).

The present invention relates to a lifting machine with a placing jib working in articulated mode or in liftable mode for lifting and handling loads, comprising a mast, a jib foot articulated for rotation at its first end at the top of the mast, and a jib head member articulated for rotation at the second end of the jib foot, the said jib head member having, on each side of its axis of articulation at the jib foot, respectively a jib head member tip and a counter jib head member, a jib holding assembly comprising at least one stay and a jib tie, and at least one double-acting articulation jack connecting the jib foot to the jib head member, determining the angle between the jib foot and the jib head member.

To allow the handling of loads on construction sites, use is habitually made of an orientable horizontal placing jib on which a bogie slides, serving as a guide for suspension means.

In some circumstances, for example when the sites are crowded or when national legislation prohibits travelling over plots adjacent to the site, either cranes with a liftable and orientable placing jib or cranes with an orientable articulated placing jib are preferred. Cranes with a liftable placing jib have the advantage, compared with horizontal-jib cranes with comparable mast heights, of being able to take loads to greater heights.

However, these two types of crane have certain drawbacks compared with horizontal-jib cranes. Firstly, their minimum reach being relatively high, the manipulation of loads in the immediate vicinity of the crane base cannot be ensured. Secondly, it is very difficult to control an evenness of the speed of distribution of the loads which makes it possible to prevent any unwanted swaying.

The patent FR 2605619 describes a crane of the type defined at the beginning which combines the effects of a crane with an articulated placing jib with those of a liftable placing jib crane, thus conferring on it a certain multipurpose character. In addition, the mast of this crane has the advantage of being able to be unfolded and folded, and this automatically.

However, because of the design of the articulations of the placing jib, this crane always has a long minimum reach. In addition, the gain in height under the hook obtained when the tip of the jib is raised remains relatively small, not being able to exceed an angular amplitude equivalent to 30° compared with respect to the horizontal, because of the angle always formed between the jib head member and the jib foot.

Moreover, when this crane is folded up and placed on a travelling carrying chassis especially designed for its transportation, the road-going assembly thus formed is just able to pass under a four-metre clearance, enabling it to access the road network. However, this assembly cannot run on some secondary routes with a restricted clearance.

The aim of the present invention is to produce a lifting machine with a multipurpose orientable placing jib being able to be used equally well as a crane with a liftable placing jib or as a crane with an articulated placing jib or as a crane with an inclinable jib head member, the conversion from one function to another having to take place as simply as possible.

Another aim of the present invention is the production of a lifting machine with a multipurpose orientable placing jib which, when it operates as an articulated placing jib crane, has a very low minimum reach but a maximum reach which is as great as possible.

Another aim of the present invention is the production of a lifting machine with a multipurpose orientable placing jib capable of distributing a load at an even speed, in particular at a constant horizontal speed when it is operating as an articulated placing jib crane.

Yet another aim of the present invention is the production of a lifting machine with a multipurpose orientable placing jib which, when it is operating as a liftable placing jib crane, affords a height under the hook which is as high as possible.

Finally, the aim of the present invention is the production of a lifting machine with a multipurpose orientable placing jib which, when the jib is articulated on an articulated mast, can be folded in the most compact manner possible so that it can be placed in a container of the maritime type with a view to its transportation.

For this purpose, the object of the present invention is a lifting machine with an orientable placing jib operating in articulated mode or in liftable mode for lifting and handling loads as defined at the beginning, in which the part of the jib foot adjacent to the said second end and the counter jib head member have conjugate shapes enabling the jib head member tip to come into a position which is aligned with the jib foot.

The jib tie can be connected to the jib head member tip by passing through at least one lifting counterbrace fixed to the jib head member.

The lifting counterbrace can be arranged substantially at the junction between the counter jib head member and the tip of the jib head member.

The counter jib head member and the part of the jib foot adjacent to its second end can have prismatic profiles and can come into contact against each other when the jib foot and jib head member are aligned.

The part of the jib foot adjacent to its second end can have the shape of a fork with two arms and the counter jib head member can come to be housed in the space between the two arms.

The jib foot can consist of two parallel beams and the counter jib head member can come to be housed in the space between the two beams.

The jib foot and the jib head member can be connected by two identical articulation jacks, mounted symmetrically with respect to the vertical plane of symmetry of the lifting machine.

The articulation jack or jacks can connect the jib foot directly to the counter jib head member.

The articulation jack or jacks can directly connect the jib foot and the jib head member tip.

Each articulation jack can connect the jib foot and the jib head member by means of two links.

The two links can be articulated on each other and on the jack by means of the same axis of rotation.

According to a preferred embodiment of the invention, particularly advantageous for tower cranes, the lifting machine comprises a movable counterweight whose position is slaved to the angle of inclination of the jib foot. The movable counterweight thus balances the crane according to the position of the jib.

This movable counterweight can be fixed to a first end of a pivoting counterweight arm, the second end of which is rotationally articulated on the turret or platform of the lifting machine, on the opposite side to the jib. The counterweight is connected to the jib, close to the jib foot/jib head member articulation by at least one counterweight cable passing over the stay. The presence of the counterweight cable or cables makes it possible to reduce the size of the jib lifting cable and motor. This counterweight cable can be fixed to the jib head member, in particular to the reinforced part of the jib head member/jib foot articulation.

The other end of the counterweight cable can be fixed to the platform, the counterweight cable passing over a pulley carried by the pivoting counterweight arm. In this way the angle of the pivoting arm, and consequently the holding moment of the counterweight, is directly slaved to the angle of the jib without using any auxiliary motor.

For the counterweight cable to remain perfectly tensioned, even when the jib foot is completely raised, the pulley can be connected to the pivoting counterweight arm by a pulley arm which is also pivoting, articulated on the counterweight arm, and the assembly formed by this pulley and the pulley arm can comprise weighting means for tensioning the counterweight cable.

The lifting machine preferably has two counterweight cables passing respectively on each side of the jib foot.

In order to facilitate the understanding of the invention, and of its characteristics and advantages, several embodiments are presented below with reference to the drawing, in which:

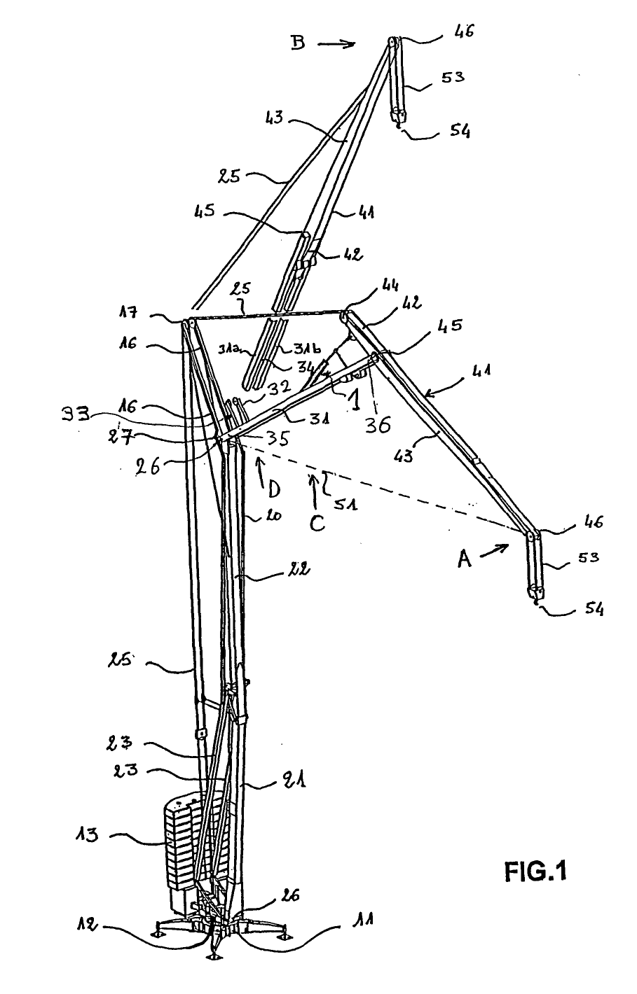

FIG. 1 depicts in perspective a first embodiment of the lifting machine with a placing jib in the working position in articulated mode and, in the background, in liftable mode;

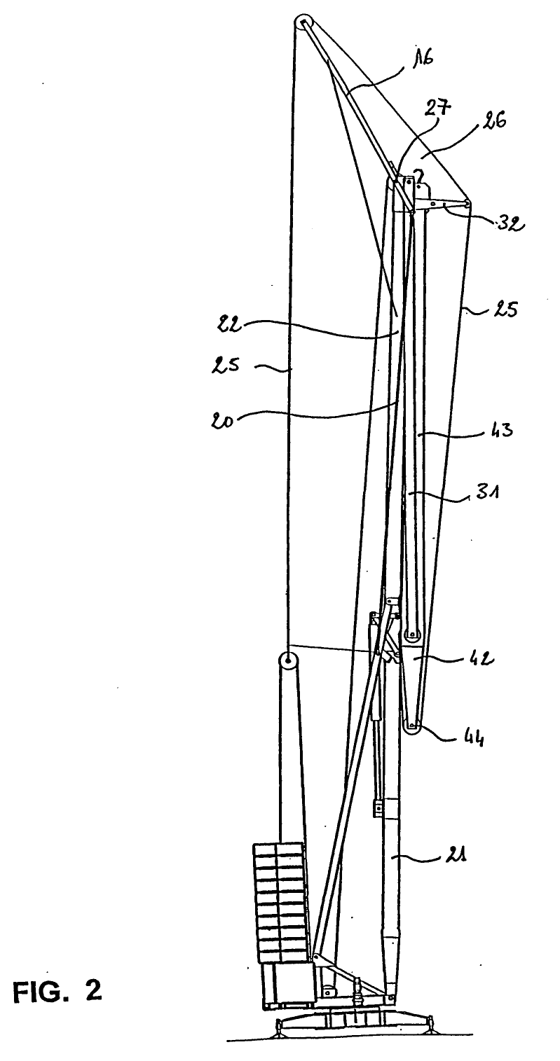

FIG. 2 depicts, by means of an elevation view, the first embodiment of the lifting machine having a placing jib in the folded position along the mast;

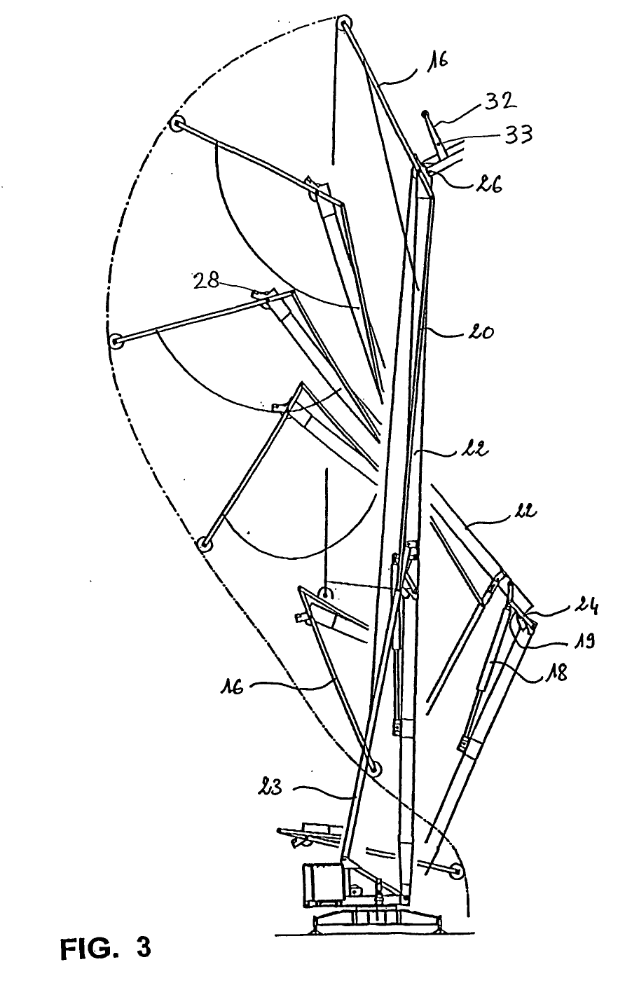

FIG. 3 depicts, by means of superimposed views in elevation, various steps of folding the mast of the first embodiment of the lifting machine;

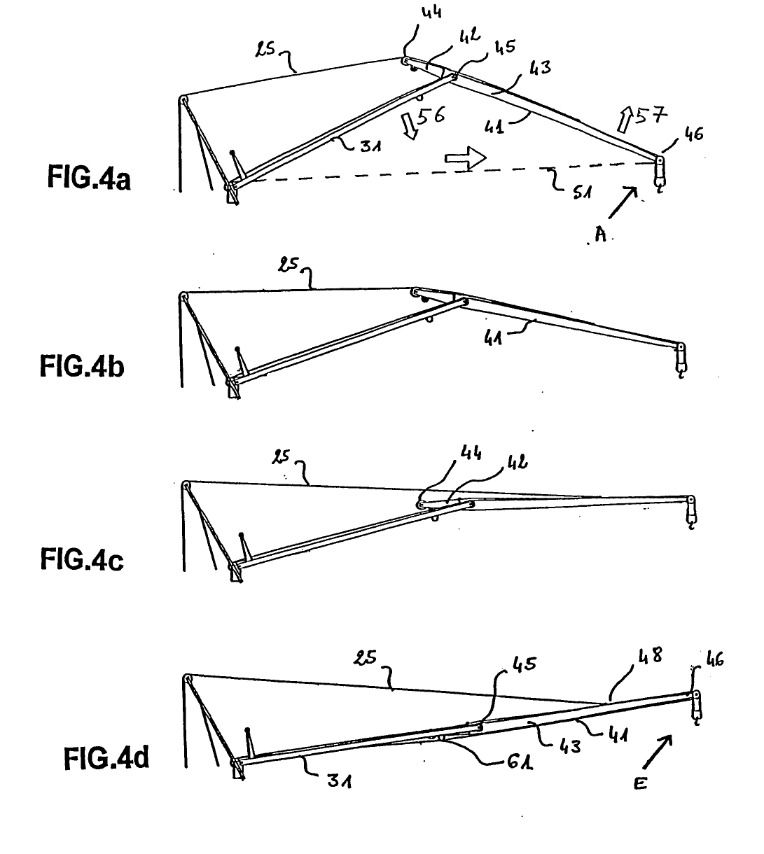

FIGS. 4a to 4d depict, by means of views in elevation, the various steps of conversion from the articulated mode to the liftable mode of the placing jib of the first embodiment of the lifting machine;

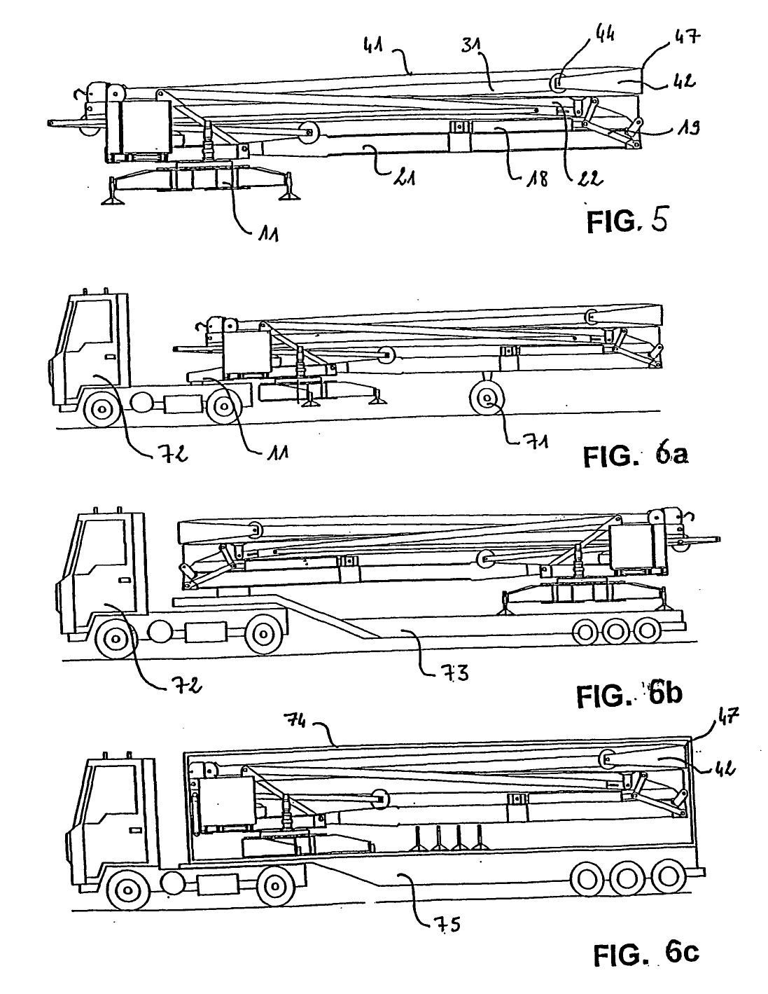

FIG. 5 depicts, by means of a view in elevation, the first embodiment of the lifting machine in the folded position;

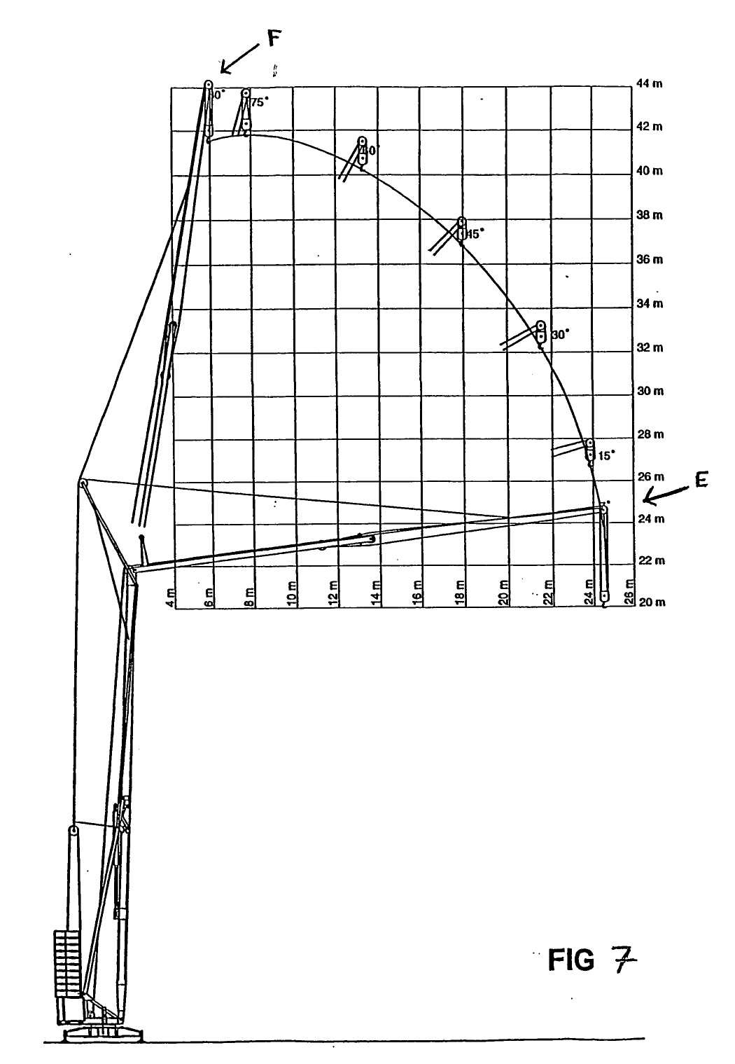

FIGS. 6a to 6c depict, by means of views in elevation, various means for transporting the first embodiment of the lifting machine;

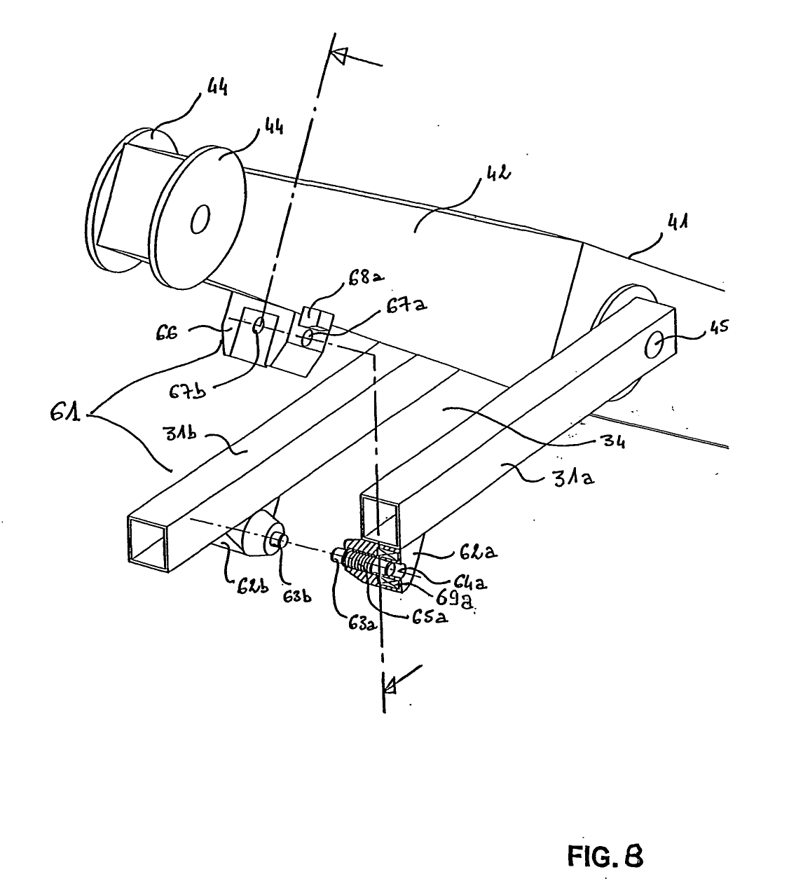

FIG. 7 depicts, by means of superimposed views in elevation, various phases of operation of the first embodiment of the lifting machine with a placing jib in the working position in liftable mode;

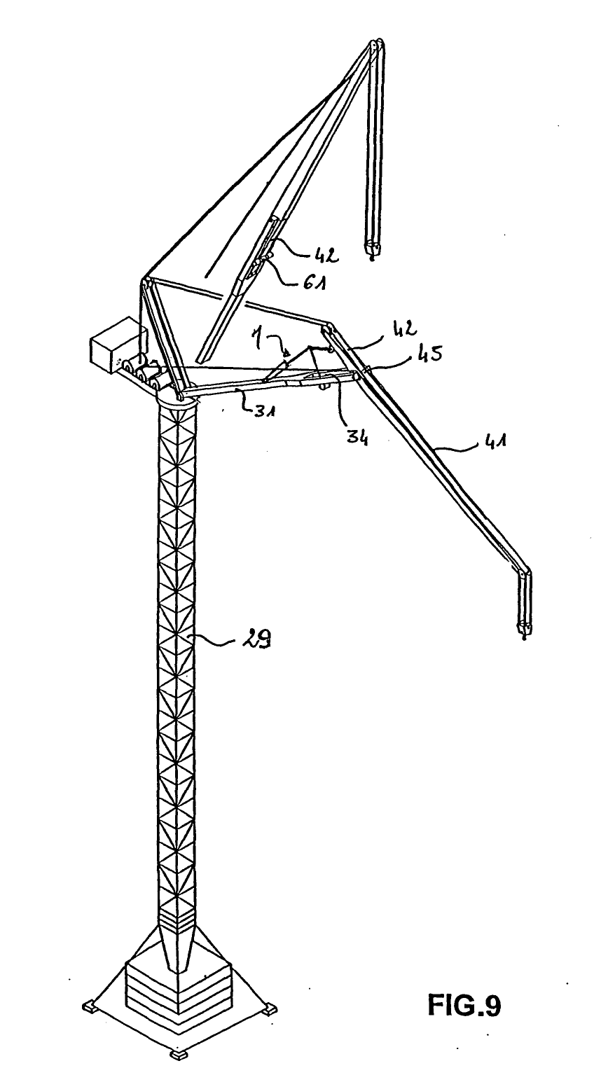

FIG. 8 depicts, by means of a view in perspective, a detail of a device for locking the placing jib in the working position in liftable mode of the second embodiment of the lifting machine;

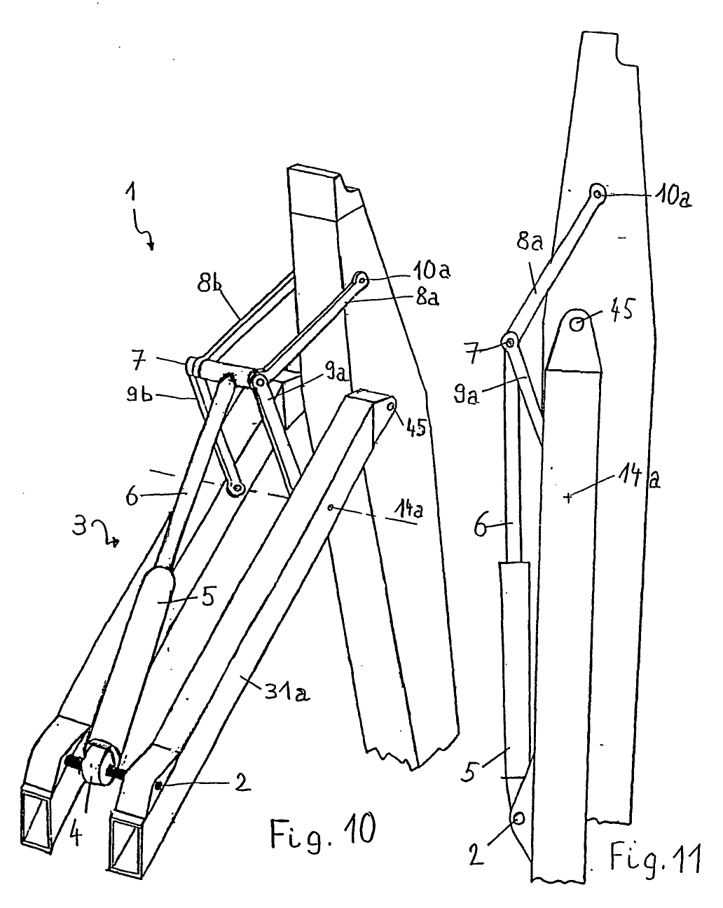

FIG. 9 depicts in perspective a second embodiment of the lifting machine with a placing jib in the working position in articulated mode and, in the background, in liftable mode;

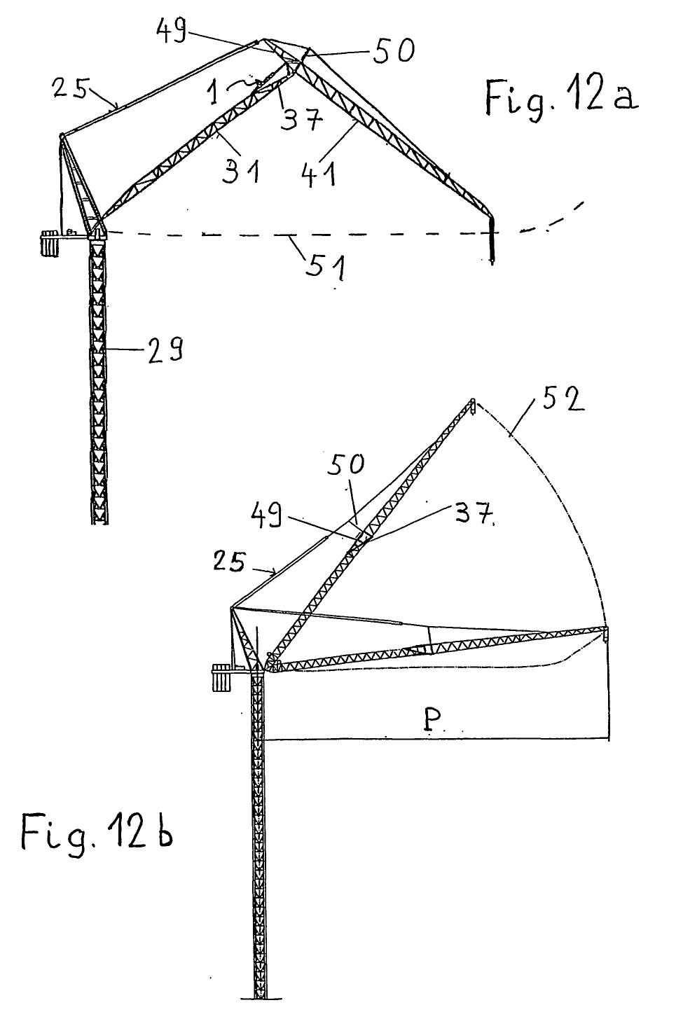

FIG. 10 depicts, by means of a perspective view, the articulation by jack between jib foot and jib head member of a variant of the second embodiment of the lifting machine in the working position in articulated mode;

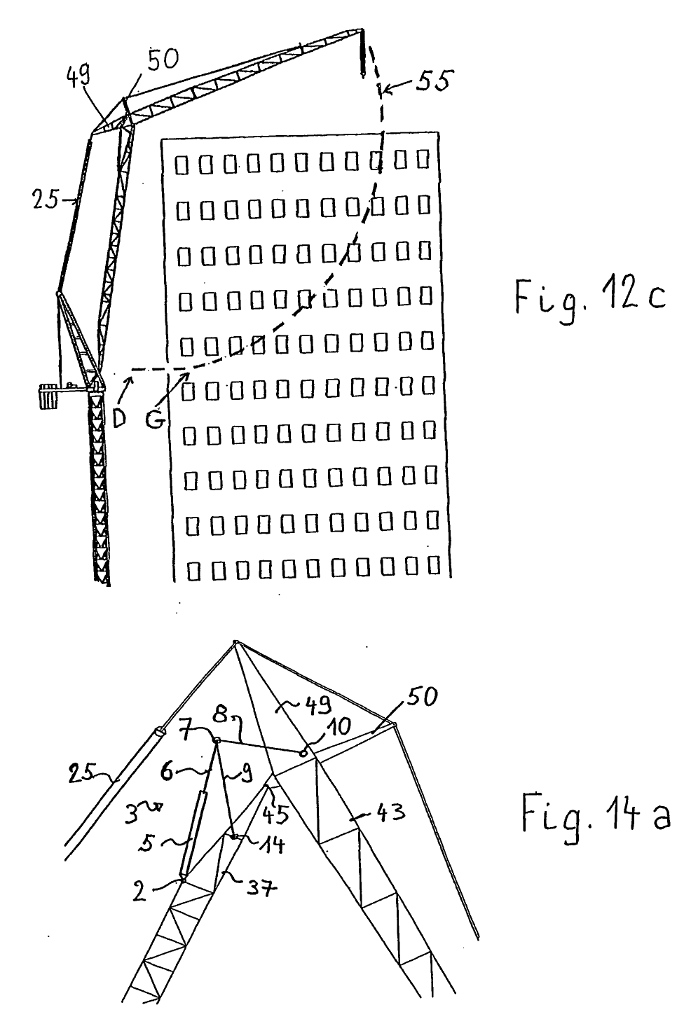

FIG. 11 depicts, by means of a view in elevation, the articulation by jack between jib foot and jib head member of the variant in FIG. 10, with the placing jib in the folded position;

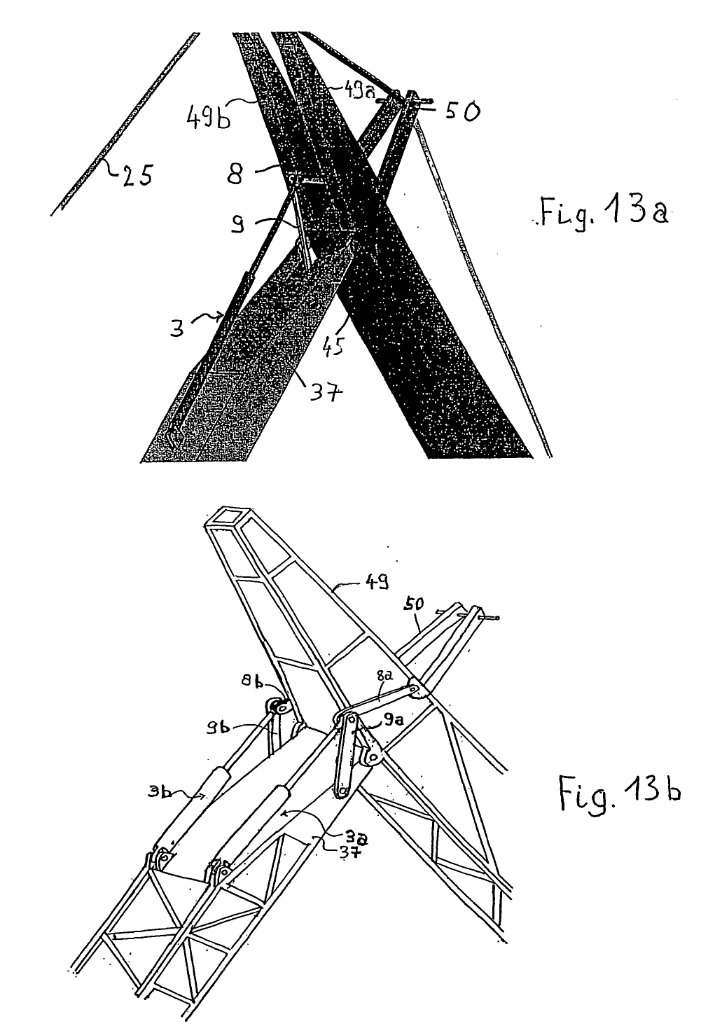

FIGS. 12a, 12b and 12c depict, by means of schematic views in elevation, a third embodiment of the lifting machine, with its placing jib respectively in articulated, liftable and inclinable mode;

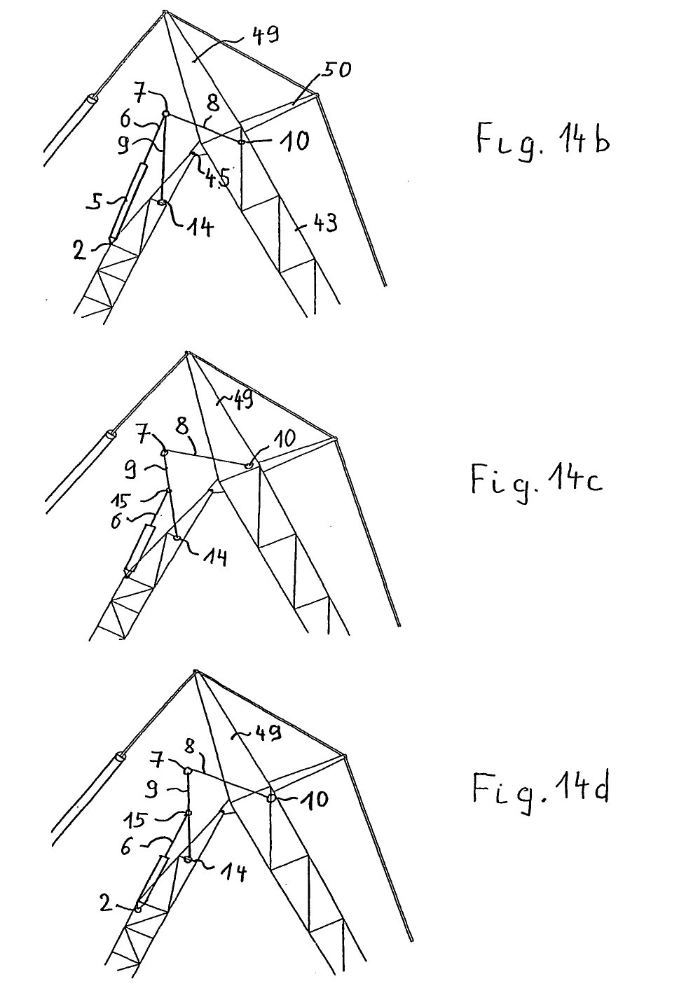

FIGS. 13a and 13b depict, by means of perspective views, the articulation, respectively with one jack and two jacks, between jib foot and jib head member of the third embodiment of the lifting machine in the working position in articulated mode;

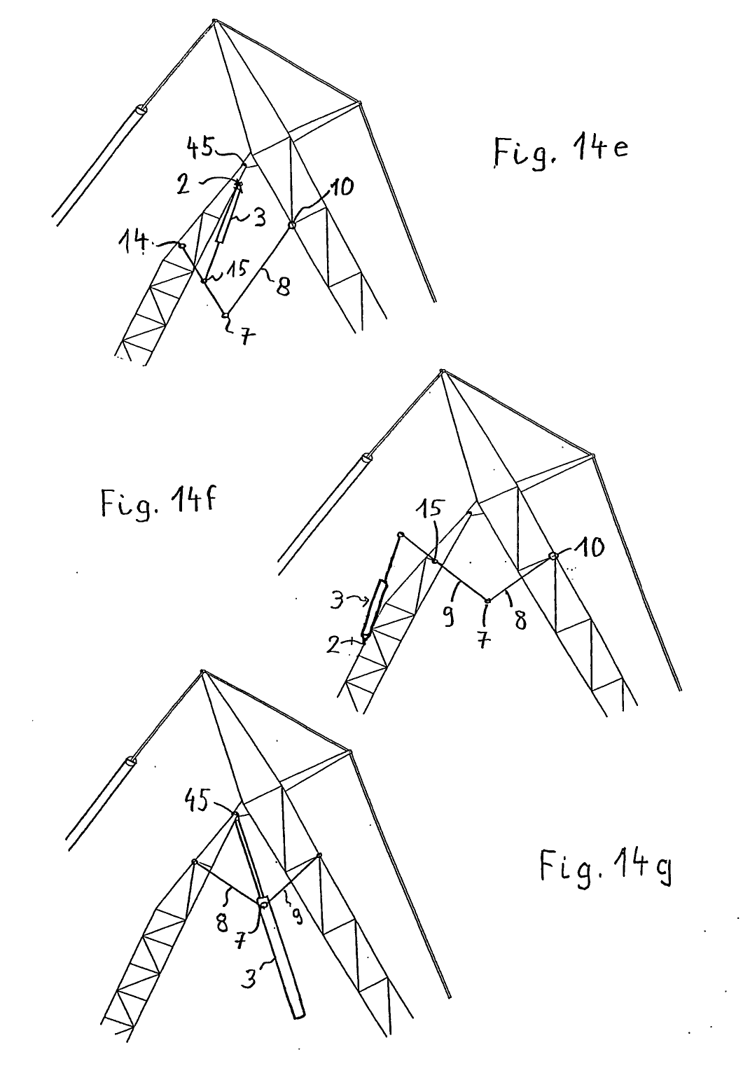

FIGS. 14a, 14b, 14c, 14d, 14e, 14f and 14g depict schematically variants of the articulation by jack or jacks between jib foot and jib head member of the third embodiment, in the working position in articulated mode;

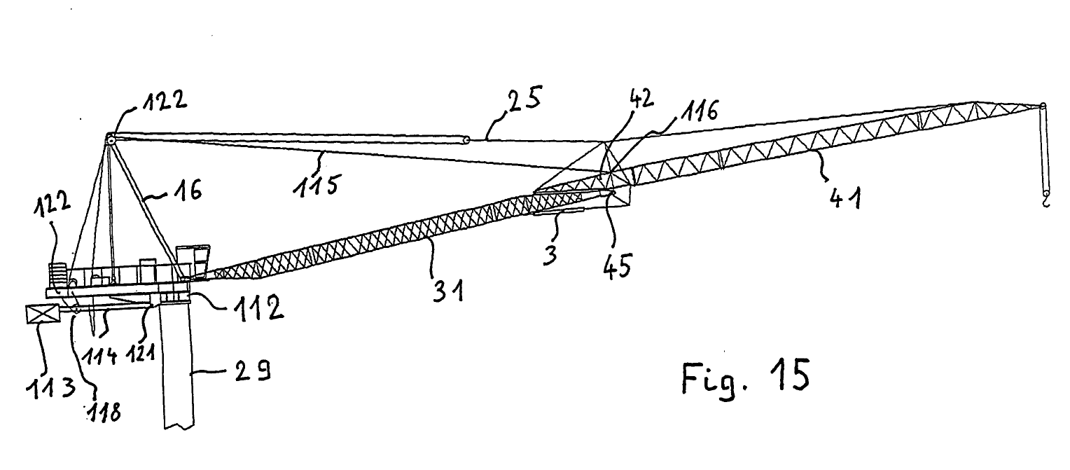

FIG. 15 depicts an embodiment of the lifting machine with a moveable counterweight;

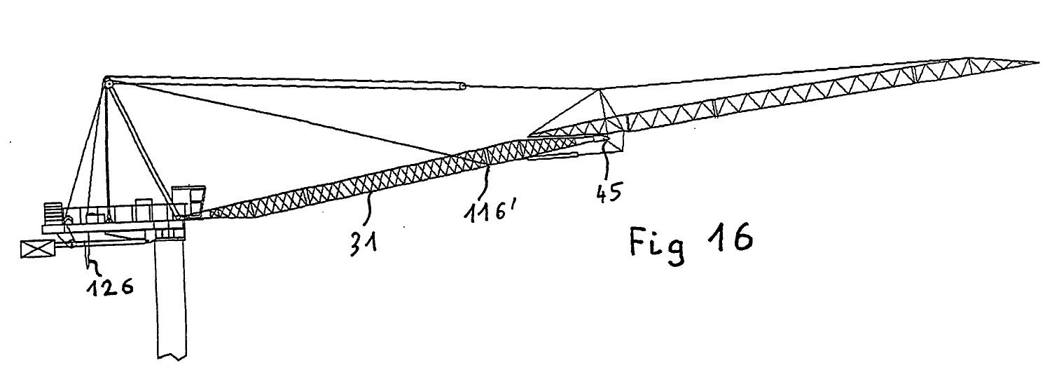

FIG. 16 depicts another embodiment of the lifting machine with a movable counterweight;

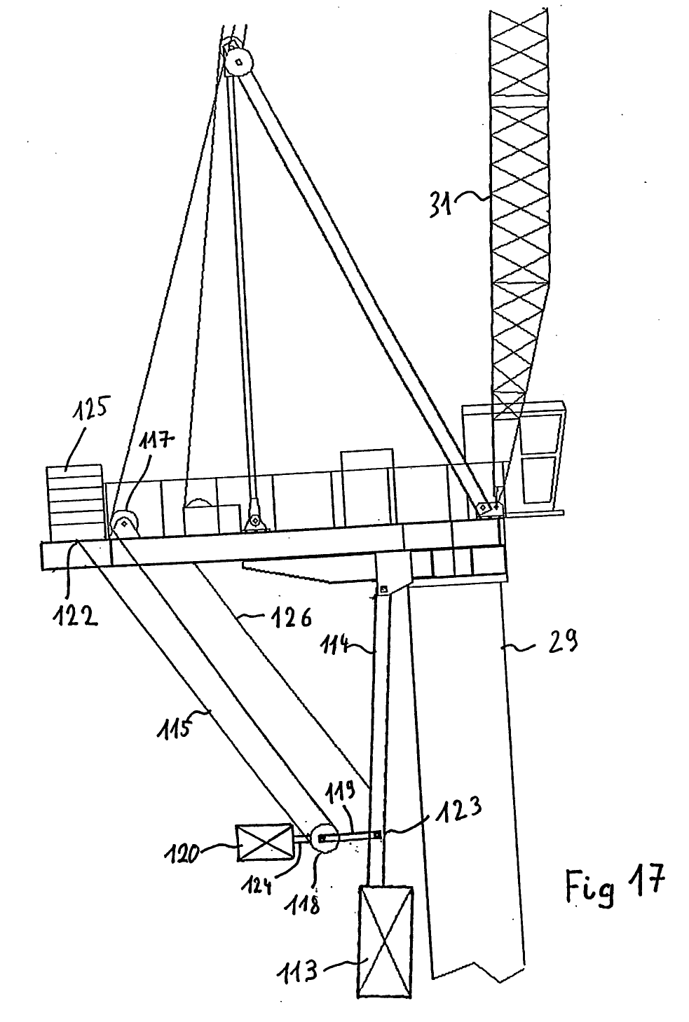

FIG. 17 depicts an enlarged view of the movable counterweight system.

In order to simplify the drafting and facilitate understanding of the invention, identical reference numbers have been given in several figures to identical or equivalent parts of several variant embodiments.

The first embodiment of the lifting machine with an orientable placing jib working in articulated mode or in liftable mode for lifting and handling loads as depicted in FIG. 1 comprises a foldable mast consisting of two portions articulated on each other, namely a mast foot 21 and an upper mast 22. The mast foot is mounted so as to pivot about a horizontal axis on the front part of a rotating chassis or turret 12. The upper mast carries, pivoting about a horizontal articulation 26, firstly an articulated liftable placing jib 31, 41 and secondly two symmetrical stays 16 connected at their end by a shaft carrying two pulleys 17. The turret 12 is mounted so as to pivot about a vertical axis on a carrying chassis 11.

The mast is held in working position by means of a set of elements consisting of a ballast 13 fixed to the rear part of the turret 12, raising counterbraces 23 connecting the mast to the turret, two ties 25 all connected to a control device, not shown in the drawing, which may for example be a winch placed on the turret 12, the two ties passing respectively over the two pulleys 17 of the stays 16.

The articulated liftable placing jib consists of two master parts, namely a jib foot 31 and a jib head member 41, articulated on each other.

The bottom end 35 of the jib foot 31 is connected, by means of the horizontal articulation 26, to the top of the upper mast 22. The other end 36 of the jib foot is connected, by means of a horizontal articulation 45, to the jib head member 41. The articulation 45 divides the jib head member into two asymmetric parts, namely a counter jib head member 42, carrying two pulleys 44 at its end, and a jib head member tip 43, carrying at its end 46 two pulleys guiding load suspension means consisting of a lifting cable 53, a pulley block and a lifting hook 54.

As presented in the foreground in FIG. 1, when the end 46 of the jib head member tip 43 is in position A, the placing jib is in the working position in articulated mode. The ties 25 pass successively through the grooves of the pulleys 17 of the two stays 16, and then through those of the two pulleys 44 of the counter jib head member 42, and are fixed to the jib head member 41. The ties 25 form, with the jib foot 31, the two stays 16 and the counter jib head member 42, a deformable quadrilateral. This geometric configuration enables the end 46 of the tip of the jib head member 43 to move on an approximately flat and horizontal path, represented by the broken line 51.

In the background in FIG. 1, when the end 46 of the jib head member tip 43 is in position B, the placing jib is situated in the working position in liftable mode. The jib head member 41 is aligned with the jib foot 31. It can be seen that the ties 25 are fixed to the jib head member 41, close to the end 46 of the tip of the jib head member 43. In this configuration, these ties 25 now pass only over the pulleys 17 of the two stays 16, and now form a triangle with the two stays 16 and the aligned assembly consisting of the jib foot 31 and jib head member 41.

The part in the background and in perspective in FIG. 1 presenting the placing jib in the working position and liftable mode shows that the jib foot 31 consists in fact of two parallel beams 31a and 31b mounted laterally on each side firstly of the upper mast 22 and secondly of the jib head member 41.

Such a construction with two beams is advantageous. This is because the counter jib head member 42 can be housed within the slot or separation 34 between these two beams 31a and 31b and a perfect alignment of the jib head member 41 with the jib foot 31 is then obtained which, as described below, affords a gain in height under the hook which is large compared with the multipurpose jibs of the prior art which have an angled shape.

In addition, such a construction with two beams reinforces the structure of the lifting machine by offering better torsional strength.

The general movement of the assembly in articulated mode, governed by the particular geometry of the quadrilateral (44, 45, 26, 17), is known from the prior art. It is however important to demonstrate the role played by two of the components of the lifting machine, namely the movement control system and the slot between the two beams of the jib foot.

In a configuration in articulated mode in which the end 46 of the tip of the jib head member 43 is situated for example in position A, it is possible to lock the device controlling the ties 25 so as to keep the distance between the pulleys 17 and 44 constant throughout all the phases of change in the angle of articulation of the placing jib.

The device (1) controlling the articulation 45 consists of a system with links and a double-acting ram or rams, which will be described in detail below.

In order to bring the end 46 of the tip of the jib head member 43 to position D corresponding to the minimum reach of the lifting machine, the operation is carried out simply by the relative movement of the rod with respect to the cylinder of the jack or jacks. The lifting hook 43 progressively moves closer to the mast.

By virtue of this simple method for controlling the angle between jib foot and jib head member, it becomes easy to control the evenness of the translation speed of the end 46 of the jib head member tip and thus to prevent any unwanted swaying of the load during its handling.

During the horizontal movement shortening the reach, the end 46 of the tip of the jib head member 43 passes through the intermediate position C, corresponding approximately to the minimum-reach position which was obtained with the lifting machines of the prior art. Now, because of the presence of the slot or separation 34 between the two beams 31a and 31b of the jib foot 31 which enables the tip of the jib head member 43 to be housed therein, the movement can continue until it brings the end 46 of the tip of the jib head member 43 to position D, just against the jib foot. This position D corresponds to the minimum reach of the lifting machine.

Starting from this position D corresponding to the minimum reach and in order to return to position A, it suffices to effect the reverse movement of the rod of the articulation jack or jacks, whilst maintaining the locking of the device controlling the ties 25 so that the end 46 of the tip of the jib head member 43 progressively moves away from the top of the upper mast 22.

By continuing the movement beyond position A, still maintaining the locking of the device controlling the ties 25, the change from articulated mode to liftable mode of the placing jib is effected.

As shown by the white arrows 56, 57 in FIG. 4a, the jib foot 31 is lowered and the end 46 of the tip of the jib head member is raised. In FIG. 4b, the ties 25 are almost aligned with the jib head member 41. In FIG. 4c, the jib foot continues its descent, and the ties 25 are then disconnected from the pulleys 44 of the counter jib head member 42.

Finally, in FIG. 4d, the position of the point 48 of attachment of the ties 25 on the tip of the jib head member 43 becomes visible. The jib head member 41 is perfectly aligned with the jib foot 31. A locking device 61, described below, maintaining this alignment can be provided optionally, in addition to the jack system (1). The placing jib is then in the working position in liftable mode. The end 46 of the tip of the jib head member 43 being in position E, the placing jib is already inclined by a few degrees with respect to the horizontal.

FIG. 8 presents in detail the elements constituting the locking device 61 fixed on the one hand to each of the two beams 31a and 31b of the jib foot 31 and on the other hand to the counter jib head member 42 of the jib head member 41 and co-operating together in order to keep the jib head member 41 and jib foot 31 aligned. To facilitate understanding of this, the ties and the system of articulation jacks have been omitted from this figure.

Below each of the two beams 31a and 31b there are mounted, projecting and placed opposite, respectively a piece 62a and a piece 62b. In each of these two pieces there is a locking cylinder respectively 63a and 63b sliding in a horizontal transverse direction respectively within the housings 64a and 64b. The locking cylinders are kept partly outside their housing under the action respectively of the springs 65a and 65b. Under the counter jib head member 42 there is, mounted projecting, a piece in the form of an inverted U 66, the two lateral faces of which are bevelled. Two holes 67a and 67b, intended to serve respectively as a housing for the external part of each of the locking cylinders 63a and 63b, have been formed respectively on the two lateral faces of the piece 66.

In the final phase of alignment of the jib head member 41 and jib foot 31, the end of the external part of the two locking cylinders 63a and 63b comes into contact with the piece 66. The bevelled shape of the lateral faces of this piece fulfilling the role of guide, the locking cylinders are progressively introduced by sliding within their respective housings 64a and 64b and the springs 65a and 65b are progressively compressed. The alignment phase continuing, the ends of the locking cylinders are situated opposite respectively the holes 67a and 67b.

The precise alignment of the cylinders 63a, 63b with the holes 67a, 67b is obtained by means of two stops 68a, placed respectively on each side of the piece 66. At this particular position, under the action of the springs 65a and 65b, the locking cylinders 63a and 63b engage respectively in the two holes 67a and 67b, thus providing the locking of the jib head member aligned with the jib foot. The placing jib can then function in liftable mode.

The performance of the lifting machine in liftable mode is illustrated by FIG. 7.

The inclination of the placing jib obtained at the time of alignment of the placing jib and corresponding to position E is 7° above the horizontal. A reach of more than 24 metres corresponds to the maximum reach which can be obtained with this lifting machine. The height under the hook is more than 24 metres from the height of the mast.

At position F, a maximum inclination of the jib of around 80° is obtained. The minimum reach is then 6 metres and the height under the hook is around 42 metres.

In order to return to articulated working mode, two electromagnetic devices 69a, fixed respectively to two pieces 62a and 62b, are actuated in order to allow the total withdrawal of the two locking cylinders 63a and 63b from the holes 67a and 67b. The articulation control device (1) with a jack makes it possible to break the alignment of the jib with the jib foot.

In order to fold the lifting machine completely, it is necessary first of all to place the placing jib in the position of working in articulated mode and then to bring the end 46 of the jib tip 43 to position D corresponding to the minimum reach. The jib tip 43 is then housed between the two beams of the jib foot 31.

The following step consists in releasing the ties 25. The jib foot 31, framing the tip of the jib head member 43, then tilts towards the front of the lifting machine and bears along the upper mast 22, as illustrated in FIG. 2. This is because the articulation 26, supporting the jib foot 31, is placed at the front of the upper mast. An articulation 27, supporting the two stays 16, is placed at the rear of the upper mast.

The folding of the mast is illustrated in FIG. 3 by means of a succession of superimposed views. In order to clarify the drawing, the major part of the placing jib, in a folded position folded onto the upper mast as described below, has been omitted from this figure.

As shown by FIGS. 2 and 3, the end of each of the stays 16 opposite to the one carrying the pulleys 17 is mounted for articulation on a lifting sling 20, thus preventing the tilting of the stays towards the rear of the machine, the sling being connected to a lifting counterbrace 23. The top of the mast is extended by two pieces 28 forming a stop for the two stays, thus preventing their tilting towards the front of the lifting machine. Each of the beams of the jib foot 31 carries a return bracket 32 intended for lifting the jib. On each of these brackets there is a stop 33 bearing respectively on each of the stays, thus preventing the tilting of the jib foot 31 towards the rear of the lifting machine.

By actuating a double-acting jack 18 which bears on the mast foot 21 and acts on a system of links 19, the mast folds around a horizontal articulation 24 and slopes by virtue of the presence of the lifting counterbraces 23. The lifting sleeves 20, each connected for articulation at the end of a stay 20, make these stays pivot about the articulation 27.

At the end of the folding process, all the elements of the lifting machine are situated horizontally, the upper mast 22 resting on the mast foot 21 and supporting the jib head member 41 framed by the two beams of the jib foot 31, the stays 16 and the lifting slings 20 being placed at the sides of these elements. This configuration is depicted in FIG. 5.

An additional advantage offered by the placing jib whose jib foot consists of two beams is obtained with a lifting machine having a foldable mast. It is a case of the saving in space obtained when the lifting machine is completely folded, thus allowing a wide variety of transport modes.

The fact that the jib head member 41 can be housed between the beams 31a and 31b of the jib foot 31 makes it possible to obtain a significant saving in space in terms of height. Through the compactness of the lifting machine in the folded position, many transportation possibilities are offered, none requiring the specific construction of a travelling carrying chassis. FIGS. 6a to 6c illustrate some of these possibilities.

According to FIG. 6a, the folded lifting machine is placed on a carriage 71 and its carrying chassis 11 is attached to the rear of a tractor 72. According to FIG. 6b, the lifting machine is placed on a trailer 73 articulated on a tractor 72.

According to FIG. 6c, the lifting machine is placed in a container 74 known as a “maritime container”, whose standard dimensions are 12,040 millimetres with regard to length and 2450 millimetres with regard to height. In advance and by virtue of the presence of a vertical articulation 47, the counter jib head member 42 has been folded on itself, thus offering a saving in space, this time in terms of length. The container can then be transported in a conventional manner, for example on a flat-bed trailer 75.

The lifting machine has been described above with a carrying chassis 11 resting level with the ground. Naturally it may also be mounted, whatever the type of mast making it up, on a travelling carrying chassis, possibly self-propelled.

Some of the advantages obtained using a placing jib whose jib foot has a slot enabling all or some of the jib head member to be housed have just been illustrated with a lifting machine whose mast is foldable. However, the same versatility and similar performance for the placing jib are also obtained when this foldable mast is replaced with a conventional tower or by a telescopic mast.

In a second embodiment of the lifting machine, particularly advantageous when the mast is a conventional tower 29 as depicted in FIG. 9, the jib foot 31 consists of a single beam in the form of a fork comprising a longitudinal strut 34 open at the end of the jib foot carrying the articulation 45. The length of this slot is sufficient for the counter jib head member 42 to be able to be housed therein so as to allow alignment between the jib head member 41 an the jib foot 31. A locking device similar to that (61) of the first embodiment can be provided as an option and ensures the alignment of the jib head member with the jib foot.

FIG. 10 shows the device 1 controlling the articulation between jib foot and jib head member of a variant of the second embodiment. The two arms 31a, 31b of the fork carry a transverse shaft 2 about which a jack 3 can pivot. The jack 3 is articulated on the shaft 2 through one end 4 of the jack cylinder 5. The jack rod 6 is articulated at its free end by means of a transverse shaft 7 on a system of two pairs of links 8a, 8b, 9a, 9b. Each link is articulated for rotation about the shaft 7 through one of its ends. The other end of the links 8a, 8b is articulated at 10a on the counter jib head member. The second end of each link 9a, 9b is articulated at 14a, 14b respectively on the arms 31a, 31b of the fork. When the rod 6 of the jack 3 enters the cylinder 5, the links come up against each other and the jib head member comes to be aligned with the jib foot. Conversely, when the rod 6 emerges from the cylinder 5, the jib head member tip folds against the jib foot.

A person skilled in the art will without difficulty understand that the articulation presented in FIG. 10 can also be used in the context of the first embodiment of the lifting machine, where the jib foot consists of two beams. In this case the length of the links and of the jack rod is calculated so that, when the jack rod is emerged to the maximum extent from the cylinder, the jib head member comes to be housed between the two beams of the jib foot, as illustrated in FIG. 11.

FIGS. 12a, 12b and 12c depict schematically a third embodiment of the lifting machine. The mast is a conventional tower 29. At the top of the mast there is articulated a first end 35 of a jib foot 31. The second end 37 of the jib foot takes the shape of a prism. At the apex of the prism a jib head member rotating about a horizontal shaft 45 is articulated. This articulation shaft subdivides the jib head member respectively into a jib head member tip similar to the jib head member tips of the first two embodiments and a counter jib head member 49 which, seen in side elevation, also has a prismatic profile, where the angle at the apex is chosen so that the jib head member, by rotation about the articulation 45, can come to be aligned with the jib foot as illustrated by FIG. 12b, the counter jib head member 49 being placed against the prism-shaped end 37 of the jib foot.

Two variants of this articulation and of the articulation control device 1 are illustrated by FIGS. 13a and 13b. As shown by FIGS. 13a and 13b, the second end 37 of the jib foot is a beam having the profile of a prism. At the top of the prism a jib head member is articulated at 45. In FIG. 13a, the counter jib head member consists of two symmetrical arms 49a, 49b separated by a slot. The articulation device with one jack and one pair of links comes to be housed in this slot.

In FIG. 13b, the counter jib head member consists of a single beam 49 with a prismatic profile. A double system of jacks 3a and 3b and links 8a, 8b, 9a, 9b is positioned symmetrically on each side of the counter jib head member.

Comparing FIGS. 10, 13a and 13b, a person skilled in the art will easily understand that the three articulation devices are functionally identical, although different in their structure, since the articulation of FIG. 10 comprises a single jack acting on two pairs of symmetrical links. FIG. 13a shows a single jack acting on a single pair of links moving inside the slot between the two arms of the counter jib head member and FIG. 13b shows two identical and symmetrical systems of links and jacks.

FIGS. 12a, 12b and 12c illustrate the three working modes of the lifting machine according to the invention. In each of these figures, the movement of the end 46 of the tip of the jib head member is depicted in broken lines.

In FIG. 12a, which depicts a mode of working as an articulated jib, the end 46 moves essentially along a horizontal line 51 which rises only close to the position of maximum reach. In FIG. 12b, beyond this position of maximum reach, the aligned jib rises in liftable mode along the line 52, as also illustrated by FIG. 7. FIG. 12c depicts schematically the inclinable jib head member working mode. Starting from the position of maximum reach, the jib head member tip is first of all moved in articulated mode, so that its end 46 describes a horizontal path as far as a position G. As from this position G, the angle of the jib foot with respect to the horizontal is kept constant by means of a compensation for the length of the tie 25, and, by means of the device 1 controlling the articulation jack or jacks, the jib head is raised in order to describe an arc of a circle 55 centred on the shaft 45, as illustrated by FIG. 12c. The advantage of this working mode is also illustrated by FIG. 12c, which depicts schematically high buildings in the background: this working mode makes it possible to move a load at a relatively low altitude, practically horizontal, parallel to the facade of the building, and then to lift it so as finally, after rotation of the tower of the lifting machine, to place the load on the top of the building, and this at a high reach.

The articulation between jib foot and jib head member can be achieved by means of many variants of the link and jack articulation system without departing from the scope of the invention. FIG. 14a is a schematic representation in side view of this articulation, which can represent equally well the articulation in FIG. 10 and the articulation in FIG. 13a or the articulation in FIG. 13b with regard to the arrangement of the jack 3 and the links 8 and 9. It will be noted in particular in this FIG. 14a that one end 10 of the link 8 is articulated on the counter jib head member.

The articulation depicted schematically in FIG. 14b differs from the articulation depicted in FIG. 14a in that the link 8 is articulated slightly further forward, on the other side of the articulation shaft 45, on the tip of the jib head member.

FIG. 14c shows a variant in which the link 8 is articulated at 10 at the articulation shaft 45. The free end of the jack rod is articulated at 15 on a middle area of the link 9 rather than at the articulation 7 between the link 9 and the link 8.

FIG. 14d shows a variant embodiment of FIG. 14c, in which the link 8 is articulated on the tip of the jib head member.

FIG. 14e shows another variant embodiment in which the link 8 is articulated appreciably further forwards 10 on the tip of the jib head member; the whole of the links + jack system is situated below the articulation shaft 45. The head of the jack rod is articulated at 15 in a middle area of the link 9, and the jib foot has a recess (not shown in the figure) in order to house link and jack when the jib head member folds against the jib foot.

In FIG. 14f, the link 8 is also articulated at 10 appreciably in front of the jib head member tip. In this variant, it is the middle part of the link 9 which is articulated on the jib foot, whilst the ends of the link 9 are articulated respectively at 7 and 14 on the link 8 and on the jack head.

FIG. 14g shows an articulation in which the jack rod is articulated directly on the shaft 45 between jib tip and counter jib head member, whilst the links 8 and 9 have a common articulation 7 not at the end of the jack rod but on the cylinder, close to the point where the cylinder rod emerges.

In the articulations depicted in FIGS. 14a, 14b and 14g, the presence will be noted of four horizontal rotation/articulation shafts whilst the articulations shown in FIGS. 14c, 14d, 14e and 14f have five articulation shafts.

It will also be noted that, in all the articulations shown in FIGS. 13a, 13b, 14a to 14g, the articulation shaft 45 is arranged so that the tip of the jib head member can come to be folded against the jib foot, subject, with regard to the articulations shown in FIGS. 14e and 14g, to a corresponding recess in the jib foot or in the jib head member. A person skilled in the art will easily understand that all the articulations shown in FIGS. 14a to 14g for the third embodiment are adaptable mutatis mutandis to the first two embodiments.

It should also be noted that, in FIGS. 12a-14g, the third embodiment of the jib head member carries a lifting bracket 50 situated approximately vertically in line with the jib foot/jib head member articulation. It goes without saying that the first and second embodiments of the lifting machine can also be provided with such a bracket 50.

The working in liftable mode of each of the placing jibs of the three embodiments previously described of the lifting machine takes place in an identical fashion. Once the jib head member 41 and the jib foot 31 are aligned and this position locked, by effecting a traction on the ties 25, for example by means of a winch placed on the turret 12 and not shown in the drawing, the placing jib is progressively lifted. The various amplitudes able to be obtained, depicted in FIG. 7 for the first embodiment, are obtained in a similar fashion for the other embodiments.

Such performances are comparable to those normally obtained with cranes with a placing jib functioning solely in liftable mode.

In a preferred embodiment of the invention, particularly advantageous for tower cranes as illustrated previously by FIGS. 9, 12a, 12b, 12c, the lifting machine has a movable counterweight, illustrated by FIGS. 15, 16, 17, exerting a moment of force opposite to that exerted by the jib on the pivoting turret or platform of the crane and on the mast 29, automatically adjustable according to the respective positions of the jib foot and of the jib head member.

FIG. 15 shows the upper part of the tower crane mounted on a mast 29, and comprising a pivoting platform 112. In this FIG. 15, the jib foot 31 and the jib head member 41 are aligned with each other, on each side of the articulation 45. The jib tie 25 and the articulation jack 3 can also be recognised in the figure. The bottom of the platform 112 carries, on the opposite side to the jib, a pivoting counterweight arm 114, one end 121 of which is rotationally articulated on the platform. The other end of the pivoting arm 114 carries a counterweight 113, the movement of which, and consequently the variation in the moment of force exerted on the mast 29 and the platform 112, is provided by the pivoting of the pivoting arm 114. The rotation of the pivoting arm 114 is controlled by two counterweight cables 115. One end of the counterweight cables 115 is fixed at a fixed point 122 of the platform. The two cables 115 pass through two pulleys 118 carried by the pivoting arm 114, over two return pulleys 117 fixed to the platform, and then over two pulleys 122 carried on each side by the top of the stay 16. The cables 115 are fixed to the jib head member 41 at a point 116 situated at the articulation 45, in the area where this jib head member is reinforced. The cables 115 are therefore arranged on each side of the jib foot 31 and of the counter jib head member 42.

FIG. 16 shows an embodiment of the invention which differs from the embodiment shown in FIG. 15 only through the fact that the cables 115 are fixed at points 116′ on the jib foot 31, situated close to the jib foot/jib head member articulation 45. The jib foot is reinforced at this point.

The location of the fixing point 116 or 116′ in this area close to the articulation, combined with the fact that each cable 115 passing over the pulley 118 is arranged so as to be double between the point 122 and the arm 114, makes it possible to slave the angle of inclination of the arm 114, between a substantially horizontal position and a substantially vertical position, to the angle of inclination of the jib foot, also between a substantially horizontal position and a substantially vertical position, and this without employing any additional motor winding or unwinding the cables 115.

FIG. 17 shows a particular embodiment of the pulleys 118 and their mounting on the arm 114. The pulleys 118 are carried by a pivoting pulley arm 119, mounted for rotation on the counterweight arm 114 through its end 123. The assembly formed by the pulley arm 119 and the pulleys 118 is extended by a second arm 124 to which a counterweight 120 is fixed which, by weighting the assembly formed by the pulley arm 119 and the pulleys 118, exerts a tension on the cables 115 and keeps these tensioned when the jib foot 31 is in a position close to the vertical.

An additional fixed counterweight 125 can be placed on or under the platform. The travel of the counterweight 113 in the direction of the mast 29 is limited by a stop cable 126, tensioned in FIG. 17, not tensioned in FIGS. 15 and 16.

The adjustment of the counterweights 113, 120 and 125, and the adjustment of the arms 114 and 119, makes it possible to balance the crane in an optimum fashion, in the various working modes, liftable, inclinable and articulated.

1. A machine for lifting and handling loads with an articulated liftable placing jib, comprising a mast (21, 22, 29), a jib foot (31, 31a, 31b) articulated for rotation at its first end (35) at the top of the mast, and a jib head member (41) articulated for rotation at the second end (36, 37) of the jib foot, the said jib head member having, on each side of its axis of articulation (45) at the jib foot, respectively a jib head member tip (43) and a counter jib head member (42, 49, 49a, 49b), a jib holding assembly comprising at least one stay (16) and a jib tie (25), and at least one double-acting articulation jack (3, 3a, 3b) connecting the jib foot to the jib head member, determining the angle between the jib foot and the jib head member, characterised in that the said second end of the jib foot and the counter jib head member have conjugate shapes enabling the tip of the jib head member to come into a position aligned with the jib foot.

2. A machine according to claim 1, characterised in that the jib tie (25) is connected to the tip of the jib head member (43) by passing through at least one lifting bracket (50) fixed to the jib head member.

3. A machine according to claim 2, characterised in that the lifting bracket (50) is arranged substantially at the junction between the counter jib head member (42, 49, 49a, 49b) and the tip of the jib head member (43).

4. A machine according to one of claims 1 to 3, characterised in that the counter jib head member (49, 49a, 49b) and the second end (37) of the jib foot have prismatic profiles and come into contact against each other when the jib foot and jib head member are aligned.

5. A machine according to one of claims 1 to 3, characterised in that the second end (36) of the jib foot has the form of a fork with two arms (31a, 31b) and in that the counter jib head member (42) comes to be housed in the space (34) between the two arms.

6. A machine according to one of claims 1 to 3, characterised in that the jib foot consists of two parallel beams (31a, 31b) and in that the counter jib head member (42) comes to be housed in the space (34) between the two beams.

7. A machine according to one of the preceding claims, characterised in that the jib foot (31) and the jib head member (41) are connected by two identical articulation jacks (3a, 3b), mounted symmetrically with respect to the vertical plane of symmetry of the jib.

8. A machine according to one of the preceding claims, characterised in that the articulation jack or jacks (3, 3a, 3b) directly connect the jib foot to the counter jib head member.

9. A machine according to one of claims 1 to 7, characterised in that the articulation jack or jacks directly connect the jib foot and jib head member tip.

10. A machine according to one of claims 1 to 7, characterised in that each articulation jack (3, 3a, 3b) connects the jib foot (31) and the jib head member (41) by means of two links (8, 8a, 8b, 9, 9a, 9b).

11. A machine according to claim 10, characterised in that the said links are articulated on each other and on the jack by means of the same rotation shaft (7).

12. A lifting machine with a placing jib according to one of claims 5 to 7, characterised in that it has a locking device comprising on the one hand two pieces (62a, 62b) fixed to the jib foot (31) and disposed opposite each other on each side of the slot (34), each of the said pieces being equipped with a sliding locking cylinder (63a, 63b), and on the other hand a counter piece (66) fixed to the counter jib head member (42) and having bevelled side faces each having a hole (67a, 67b), the assembly being arranged so that the cylinders (63a, 63b) can cooperate respectively with each of the holes when the jib head member is aligned with the jib foot.

13. A machine according to one of claims 1 to 12, in particular a tower crane, characterised in that it comprises a movable counterweight (113) whose position is slaved to the angular inclination of the jib foot (31).

14. A machine according to claim 13, characterised in that the said movable counterweight (113) is fixed to a first end of a pivoting counterweight arm (114) whose second arm (121) is rotationally articulated on the platform (112) of the machine, on the opposite side to the jib, and in that the said pivoting counterweight arm (114) is connected (116, 116′) to the jib close to the articulation between jib foot and jib head member by means of at least one counterweight cable (115) passing over the said stay (16).

15. A machine according to claim 14, characterised in that a first end (116) of the said counterweight cable (115) is fixed to the jib head member (41), in particular to the reinforced part of the jib head member/jib foot articulation.

16. A machine according to one of claims 14 or 15, characterised in that the second end of the said counterweight cable (115) is fixed to the platform (112) and in that the said counterweight cable (115) passes over a pulley (118) carried by the said pivoting counterweight arm (114).

17. A machine according to claim 16, characterised in that the said pulley (118) is connected to the said pivoting counterweight arm (114) by a pivoting pulley arm (119), articulated on the said pivoting counterweight arm, and in that the assembly formed by the said pulley (118) and the said pulley arm (119) comprises weighting means (120) for tensioning the said counterweight cable (115).

18. A machine according to one of claims 14 to 17, characterised in that it has two counterweight cables (115) passing on each side of the jib foot (31).
